(19) United States
(12) Patent Application Publication
(10) Pub. No.: US 2026/0270352 A1
(43) Pub. Date: Sep. 10, 2026

(54) DISPLAY CONTROL SYSTEM, INFORMATION PROCESSING APPARATUS, AND NON-TRANSITORY COMPUTER READABLE MEDIUM

(71) Applicant: FUJIFILM Business Innovation Corp., Tokyo (JP)

(72) Inventors: Yuki KANAZAWA, Kanagawa (JP); Risa HAYASHI, Kanagawa (JP); Ryosuke MASUKO, Kanagawa (JP); Natsuko KATO, Kanagawa (JP); Naoto IKEDA, Kanagawa (JP); Masanori SATAKE, Kanagawa (JP)

(73) Assignee: FUJIFILM Business Innovation Corp., Tokyo (JP)

(21) Appl. No.: 19/276,092

(22) Filed: Jul. 22, 2025

(30) Foreign Application Priority Data
Mar. 4, 2025 (JP) 2025-033444

(51) Int. Cl. H04N 1/00

(52) U.S. Cl. CPC H04N 1/00501; H04N 1/00352

(57) ABSTRACT

A display control system includes a processor configured to be capable of displaying in a first region a first image for executing, when receiving an instruction from a user, processing set in advance by the user; and be capable of displaying in a second region that is different from the first region a second image for executing, when receiving an instruction from the user, processing set in advance by an administrator.

### CROSS-REFERENCE TO RELATED APPLICATIONS

This application is based on and claims priority under 35 USC 119 from Japanese Patent Application No. 2025-033444 filed Mar. 4, 2025.

### BACKGROUND

### (i) Technical Field

The present disclosure relates to a display control system, an information processing apparatus, and a non-transitory computer readable medium.

### (ii) Related Art

An image processing apparatus that determines, based on a condition stored in a storage device, whether or not to display on an individual home screen that is a home screen for an individual user an execution instruction image for receiving an execution instruction of an installed application program is disclosed in Japanese Unexamined Patent Application Publication No. 2019-113999. The image processing apparatus displays on a display device the individual home screen including the execution instruction image that is determined to be displayed.

### SUMMARY

A situation where, in the case where a first image for executing, when an instruction from a user is received, processing set in advance by the user is displayed, a second image for executing, when an instruction from the user is received, processing set in advance by an administrator is displayed, will be considered. In the case where the second image is displayed without being distinguished from the first image, for example, the position at which the first image is displayed may change depending on whether or not the second image is displayed.

Aspects of non-limiting embodiments of the present disclosure relate to reducing degradation of operability compared to the case where the second image is displayed without being distinguished from the first image.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a display control system including a processor configured to be capable of displaying in a first region a first image for executing, when receiving an instruction from a user, processing set in advance by the user; and be capable of displaying in a second region that is different from the first region a second image for executing, when receiving an instruction from the user, processing set in advance by an administrator.

### BRIEF DESCRIPTION OF THE DRAWINGS

Exemplary embodiments of the present disclosure will be described in detail based on the following figures, wherein:

FIG. 1 is a diagram for explaining a functional configuration of an information processing apparatus;

FIG. 2 is a diagram for explaining a functional configuration of the information processing apparatus;

FIG. 3A is a diagram for explaining an example of function control data;

FIG. 3B is a diagram for explaining an example of UI control data;

FIG. 4 is a diagram for explaining an operation panel of the information processing apparatus;

FIG. 5A is a diagram for explaining a screen example of a touch panel display;

FIG. 5B is a diagram for explaining another screen example of the touch panel display;

FIG. 6A is a diagram for explaining a first switching example of switching between screens in the first exemplary embodiment;

FIG. 6B is a diagram for explaining a second switching example of switching between screens in the first exemplary embodiment;

FIG. 7 is a flowchart illustrating an example of a process;

FIG. 8 is a diagram for explaining switching between screens in a second exemplary embodiment;

FIGS. 9A, 9B, and 9C are diagrams for explaining examples of switching between screens in a third exemplary embodiment;

FIG. 10A is a diagram for explaining an application example of a case where an upward scrolling operation is performed; and

FIG. 10B is a diagram for explaining an application example of a case where a downward scrolling operation is performed.

### DETAILED DESCRIPTION

Hereinafter, exemplary embodiments of the present disclosure will be described in detail with reference to the attached drawings.

### Configuration of Information Processing Apparatus

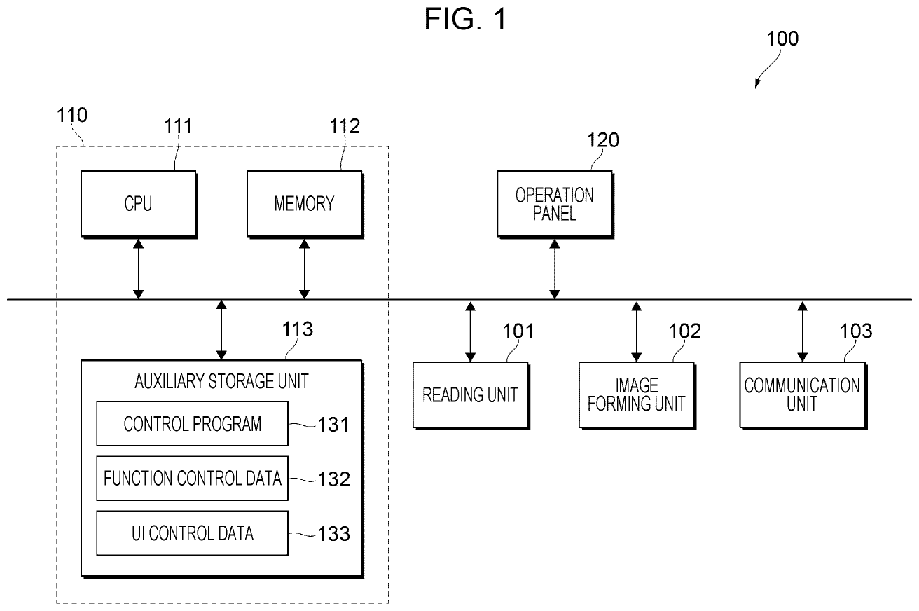

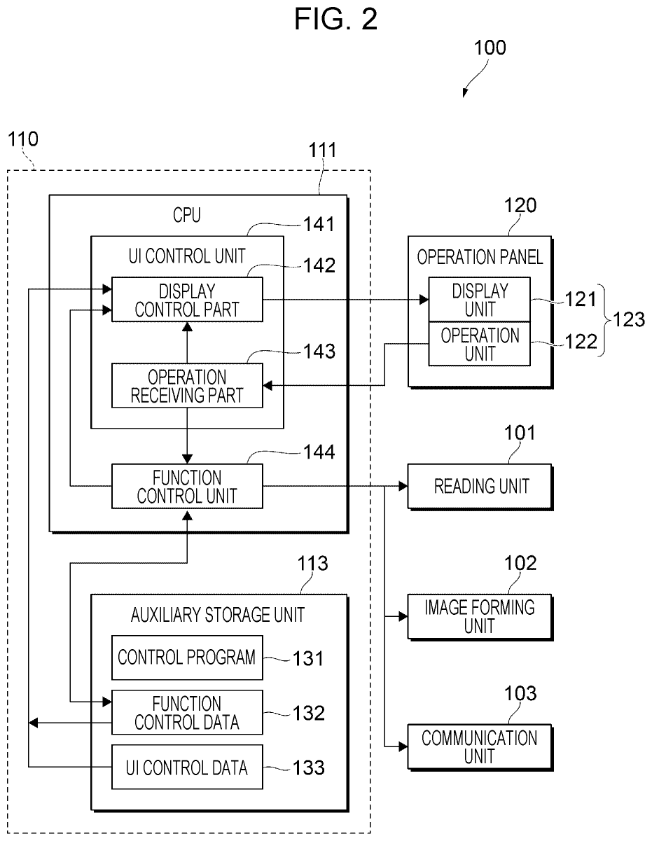

FIGS. 1 and 2 are diagrams each illustrating a functional configuration of an information processing apparatus 100.

As illustrated in FIG. 1, the information processing apparatus 100 is an apparatus or an information apparatus that is capable of executing processing of functions such as copy, print, image scan, and facsimile (FAX). The information processing apparatus 100 includes, inside its body, a reading unit 101, an image forming unit 102, a communication unit 103, and a control device 110. Furthermore, the information processing apparatus 100 includes an operation panel 120 that is provided at such a position that the operation panel 120 is visible by a user and able to be operated by the user.

These units are connected by a data bus, an address bus, a peripheral component interconnect (PCI) bus, or the like.

The information processing apparatus 100 is capable of performing data communication with an information processing apparatus such as a personal computer or a server in an office connected to, for example, a local area network (LAN) line. Furthermore, the information processing apparatus 100 is capable of performing facsimile communication with other office communication apparatuses via a public line such as a telephone line.

The information processing apparatus 100 is provided with a function for transmitting sound and images through communication.

The reading unit 101 reads an image of a document. Specifically, the reading unit 101 generates image data by optically reading an image of a document and converting the image into a digital signal.

The image forming unit 102 forms an image on a medium such as paper. Specifically, the image forming unit 102 forms an image on a medium using an electrophotographic system in which toner is electrostatically adhered onto paper so that an image is formed. The image forming unit 102 may form an image on a medium using other systems such as an inkjet system in which ink is discharged onto paper so that an image is formed.

The communication unit 103 communicates with an external apparatus such as a facsimile apparatus. Specifically, the communication unit 103 performs transmission and reception of various data to and from an external apparatus through communication using various communication lines in a wired or wireless manner. The communication lines include, for example, the Internet, an intranet, and a public telephone line.

The control device 110 is a device that controls various units of the information processing apparatus 100. Specifically, the control device 110 includes a central processing unit (CPU) 111, a memory 112, and an auxiliary storage unit 113. The control device 110 controls, based on information stored in the auxiliary storage unit 113, the information processing apparatus 100.

The CPU 111 of the control device 110 is a unit that implements various functions through execution of firmware. The CPU 111 and the memory 112 function as a computer.

The memory 112 is a storage region in which various types of software, data to be used for execution of the various types of software, and the like are stored and is used as an operation area for calculation. The memory 112 includes, for example, a read only memory (ROM), a random access memory (RAM), and the like.

The auxiliary storage unit 113 includes, for example, a hard disk device and a semiconductor storage. A program and various data are stored in the auxiliary storage unit 113. In this exemplary embodiment, a control program 131, function control data 132, and UI control data 133 are stored in the auxiliary storage unit 113.

The operation panel 120 is a user interface (UI) that the user operates in association with display. The UI is a device used for exchange of information between the information processing apparatus 100 and the user. More particularly, the UI receives an operation instruction from the user to the information processing apparatus 100 and presents information such as the status of the information processing apparatus 100 to the user.

As illustrated in FIG. 2, in this exemplary embodiment, the operation panel 120 includes a display unit 121 and an operation unit 122.

The display unit 121 of the operation panel 120 displays an operation screen, various messages such as operation guide, and the like. The display unit 121 includes, for example, a liquid crystal display, an organic electroluminescence (EL) display, or the like.

The operation unit 122 is a component unit on which the user performs an input operation.

In this exemplary embodiment, the operation unit 122 and the display unit 121 are implemented by a touch panel display 123 in which the operation unit 122 and the display unit 121 are integrated together.

More particularly, the operation unit 122 is a touch panel of a resistance film system, an electrostatic capacitance system, or the like and detects a touch operation by the user.

On the touch panel display 123, a region in which an operation screen for the display unit 121 is displayed and a region in which a touch operation of the operation unit 122 is able to be detected overlap. Thus, when the user performs a touch operation on the operation screen displayed on the display unit 121, the operation unit 122 detects that the touch operation has been performed on the operation screen. Furthermore, the operation unit 122 detects a position at which the touch operation has been performed on the operation screen. A detection signal of the operation unit 122 is output to the control device 110.

Touch operations by a user include operations such as tapping, flicking, sliding, and dragging. A tapping operation is an operation of touching with a finger the screen of the display unit 121. A flicking operation is an operation of touching with a finger the screen of the display unit 121 as if the screen was swept with the finger. A sliding operation is an operation of moving a finger while touching with the finger the screen of the display unit 121.

A dragging operation is an operation of moving an image such as an icon displayed on the display unit 121. A dragging operation is an operation of touching with a finger an image displayed on the display unit 121, moving the finger while touching with the finger the image, and then removing the finger from the image.

The operation unit 122, which is a touch panel, outputs, as a detection signal, the trajectory of movement of a finger in a touch operation mentioned above on the operation screen. A touch operation is not necessarily an operation using a finger of a user but may be an operation using a tool such as a touch pen.

The user is able to operate the information processing apparatus 100 through an operation image (graphical user interface (GUI)) displayed on the operation panel 120. Furthermore, the information processing apparatus 100 may be operated through an operation screen displayed on a display provided on an external apparatus, which is not illustrated in drawings. In this case, an application for operating the information processing apparatus 100 is installed into the external apparatus.

The display unit 121 is capable of displaying various operation screens such as a task item selection screen. The operation screen may be a screen provided to operate the information processing apparatus 100. That is, although the operation screen may be an operation screen to be used for operation provided at the information processing apparatus 100, the operation screen may be a screen provided at an apparatus for remotely operating the information processing apparatus 100.

As illustrated in FIG. 2, the CPU 111 of the control device 110 functions as a UI control unit 141 and a function control unit 144 by executing the control program 131.

The UI control unit 141 receives an operation instruction received from the operation panel 120 and outputs the received operation instruction to the function control unit 144. Furthermore, the UI control unit 141 controls the touch panel display 123.

The UI control unit 141 includes, as a functional configuration, a display control part 142 and an operation receiving part 143.

The display control part 142 of the UI control unit 141 performs control for causing various operation screens to be displayed on the display unit 121 of the touch panel display 123 by referencing the function control data 132 and the UI control data 133. The control device 110 including the display control part 142 is an example of a display control system.

The operation receiving part 143 receives an operation instruction based on a user operation received from the operation panel 120. For example, the operation receiving part 143 receives a user's touch operation detected by the operation unit 122 of the touch panel display 123.

The function control unit 144 controls the reading unit 101, the image forming unit 102, and the communication unit 103 while referencing the function control data in accordance with an operation instruction received from the UI control unit 141. Furthermore, the function control unit 144 outputs execution results, statuses, and the like of processing by the reading unit 101, the image forming unit 102, and the communication unit 103 to the UI control unit 141.

The auxiliary storage unit 113 stores various programs and various data. Specifically, the various programs include the control program 131. Furthermore, the various data include the function control data 132 and the UI control data 133.

The control program 131 in the auxiliary storage unit 113 is a program for causing a computer including the CPU 111 to function as the control device 110.

The function control data 132 is data used to control the reading unit 101, the image forming unit 102, and the communication unit 103.

The UI control data 133 includes various data used for display on the display unit 121.

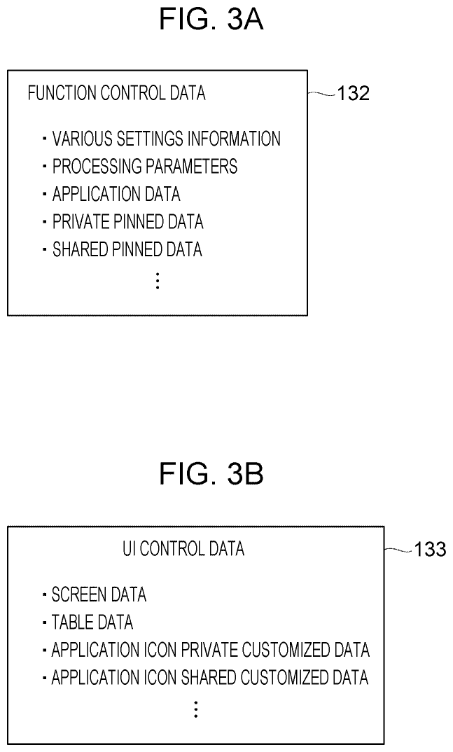

FIGS. 3A and 3B are diagrams for explaining examples of various data included in the function control data 132 and the UI control data 133. FIG. 3A illustrates the function control data 132, and FIG. 3B illustrates the UI control data 133.

In the data example illustrated in FIG. 3A, the function control data 132 includes various settings information, processing parameters, application data, private pinned data, and shared pinned data.

The various settings information in the function control data 132 includes information for defining processing conditions of a copy function, a scan function, a print function, and the like. These functions are implemented by the reading unit 101, the image forming unit 102, and the communication unit 103.

In the case of the copy function and the print function, setting information mentioned above is, for example, information for defining processing conditions such as paper size and color setting (for example, black and white copy or color copy). Furthermore, in the case of the scan function, setting information is information for defining processing conditions such as reading resolution and color setting (for example, black and white reading or color reading). Setting information includes user setting information set by a user as well as default setting information. Furthermore, the various settings information includes, for example, a history of user setting information previously used by a user.

The processing parameters in the function control data 132 include, for example, parameters used to execute image correction processing such as gain correction, contrast correction, white balance correction, and gamma correction.

The application data in the function control data 132 is data of an application for the information processing apparatus 100 to be provided to a user.

Furthermore, the private pinned data represents data indicating an icon pinned by a user. The shared pinned data represents data indicating an icon pinned by a machine administrator.

In the data example illustrated in FIG. 3B, the UI control data 133 includes screen data, table data, application icon private customized data, and application icon shared customized data.

The screen data in the UI control data 133 include various data configuring an operation screen displayed on the display unit 121. The table data include various data defining various setting items displayed on the operation screen.

The application icon private customized data in the UI control data 133 represents data indicating contents of an icon customized by a user. The application icon shared customized data represents data indicating contents of an icon customized by a machine administrator.

“Customized” mentioned above represents display/hide setting of an icon and position setting for the case where the icon is displayed.

In the various settings information in the function control data 132 and the UI control data 133, setting items for setting processing conditions for individual functions are stored for the individual functions, so that the control device 110 is able to perform settings of various functions of the information processing apparatus 100 in an orderly manner.

The “setting items” mentioned above represent items for performing a setting operation for processing conditions of various functions of the information processing apparatus 100. The information processing apparatus 100 in this example is provided with major four functions of a multifunction machine such as a copy function, a scan function, a facsimile function, and print function and is capable of setting processing conditions for the individual functions. A setting item is an item for defining a processing condition. For example, in the case where the copy function and the print function are selected, paper size, color mode (for example, black and white copy or color copy), and the like are setting items set as processing conditions.

### Operation Panel of Information Processing Apparatus

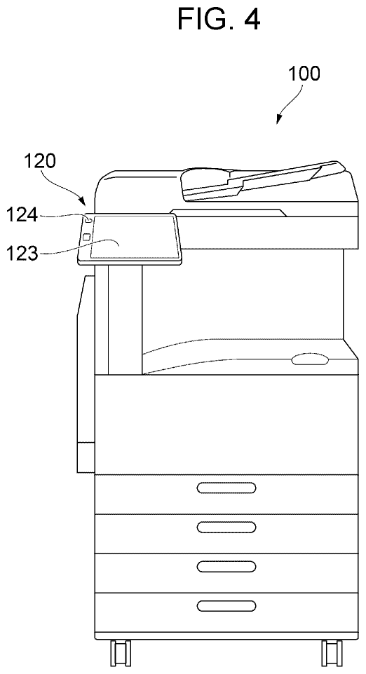

FIG. 4 is a diagram for explaining the operation panel 120 of the information processing apparatus 100. The information processing apparatus 100 is a shared apparatus that is logged into and used by a plurality of users. Furthermore, the information processing apparatus 100 may be configured to be shared among a plurality of networks.

As illustrated in FIG. 4, the operation panel 120 is arranged in the front part of the information processing apparatus 100.

The operation panel 120 includes, in addition to the touch panel display 123 described above, an operation key 124.

The operation key 124 is arranged outside the screen of the touch panel display 123. The operation key 124 includes a power key for turning on the power of the information processing apparatus 100, a switching key for switching between screens, a cancel key for cancelling various executions, and the like.

As described above, the operation panel 120 in this exemplary embodiment includes the operation key 124, which is a mechanical element, as a part to be operated by a user, in addition to the touch panel display 123 including the operation unit 122.

An operation on the operation key 124 as a switching key for switching between screens is an example of an operation on a switching button.

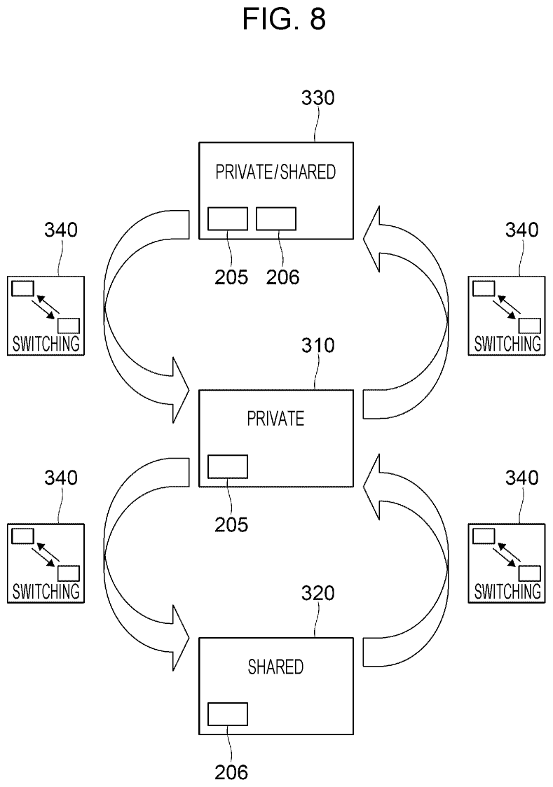

An image to be operated by a user (for example, see a switching image 340 in FIG. 8) is able to be displayed on the touch panel display 123 of the operation panel 120.

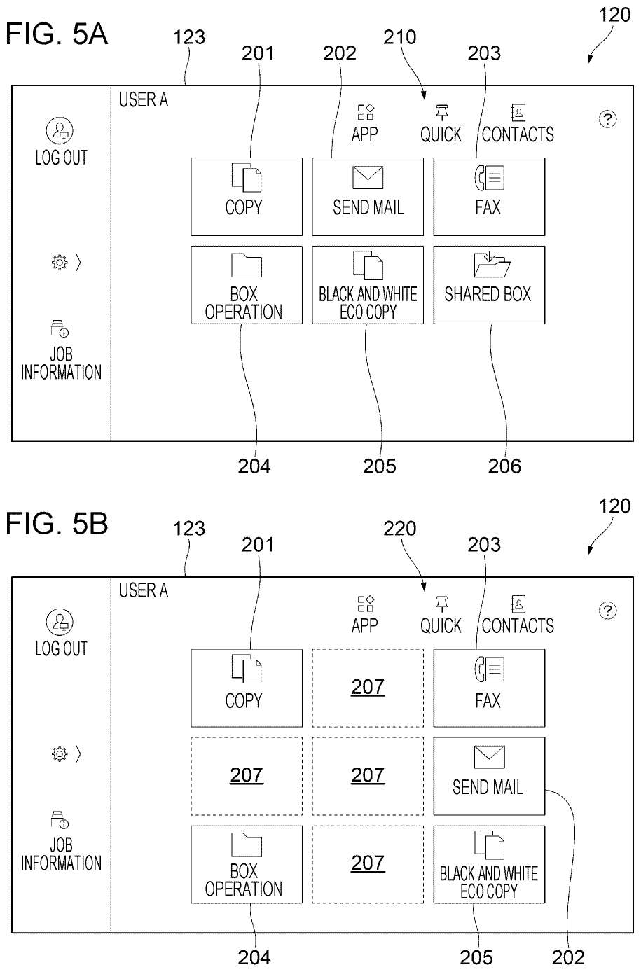

FIGS. 5A and 5B are diagrams for explaining screen examples of the touch panel display 123. FIG. 5A illustrates a function selection screen 210 as a screen example, and FIG. 5B illustrates a function selection screen 220 as another screen example.

The function selection screen 210 or 220 illustrated in FIG. 5A or 5B is a screen displayed when a user A logs in. Each of the function selection screens 210 and 220 is a selection screen that allows the user A to select various functions to be executed by the information processing apparatus 100. The function selection screen may be called an “application screen.”

The function selection screens 210 and 220 each include a plurality of sections. On the function selection screens 210 and 220, icons 201, 202, 203, 204, 205, and 206 corresponding to functions to be executed by the information processing apparatus 100 are arranged in individual sections. When one of the icons 201 to 206 is touched, processing set in advance for the touched icon is performed.

For each of the icons 201 to 206, display/hide setting is able to be customized.

On the function selection screen 210 illustrated in FIG. 5A, positions of the icons are not customized. On the function selection screen 220 illustrated in FIG. 5B, positions of the icons are customized. A specific description will be provided below.

On the function selection screen 210 illustrated in FIG. 5A, the icons 201 to 206 are arranged in a predetermined order. When one of the icons 201 to 206 is pressed, an instruction from the user is received, and processing set in advance is performed.

Out of the icons 201 to 206, the icons 201 to 204 are standard icons for which operations such as addition and deletion and display/hide setting are able to be performed by the user.

The icon 205 is a private customized application icon added by the user A. The icon 205 is an image for executing processing set in advance by the user A.

More particularly, as illustrated in FIG. 5A, the name of the icon 205 is “black and white eco copy.” For example, print settings such as “the number of copies to be printed is 1,” “black and white mode,” “double-sided print,” “2 pages per sheet,” and the like have been performed for the icon 205. The icon 205 is created by, for example, pinning a frequently used job from among job histories stored for each user.

The icon 206 is a shared pinned icon added by a machine administrator. The icon 206 is created by, for example, storing, as a pin, a job executed when logged in in a machine administrator mode.

In the example illustrated in FIG. 5A, the icon 206 is about an application of a shared box. In the icon 206, networks used for individual boxes are set in the case where the information processing apparatus 100 is shared among a plurality of networks. Thus, a box operation is shared. The name of the icon 206 is set by the machine administrator.

A shared pinned icon mentioned above is automatically added for a plurality of users including the user A, independent of an operation of the user A. Thus, the machine administrator is able to easily share an icon created by the machine administrator. Apart from the case where the machine administrator chooses to add a shared pinned icon for all the users, the machine administrator may choose to add a shared pinned icon for part of the users.

For the convenience of explanation, on the function selection screen 210 in FIG. 5A, one private customized application icon and one shared pinned icon are displayed. However, a plurality of private customized application icons and a plurality of shared pinned icons may be displayed on the function selection screen 210.

On the function selection screen 220 illustrated in FIG. 5B, the icons 201 to 205 are arranged at positions set by the user. That is, the arrangement order and the layout position of the icons 201 to 205 are able to be customized. Thus, the icons 201 to 205 are arranged in such a manner that the user is able to easily use the icons 201 to 205.

On the function selection screen 220, margins 207 in which no icon is arranged are provided in regions between icons. The icons 201 to 205 are not arranged all together in a concentrated manner. With the layout including the positions of the icons 201 to 205 and the margins 207, the icons 201 to 205 are arranged in a spread-out manner so that the user is able to distinguish between the icons 201 to 205. Thus, by remembering the positions and functions of the icons 201 to 205, user operability is improved. That is, even without checking functions of the icons 201 to 205 every time the user performs an operation, the user is able to select a desired icon.

On the function selection screen 220 illustrated in FIG. 5B, the icon 206 (see FIG. 5A) is not displayed. However, as described later, the icon 206 may be displayed on another screen different from the function selection screen 220. In the case where the icon 206 is displayed, for example, the layout position of the icon 206 is able to be customized.

### First Exemplary Embodiment

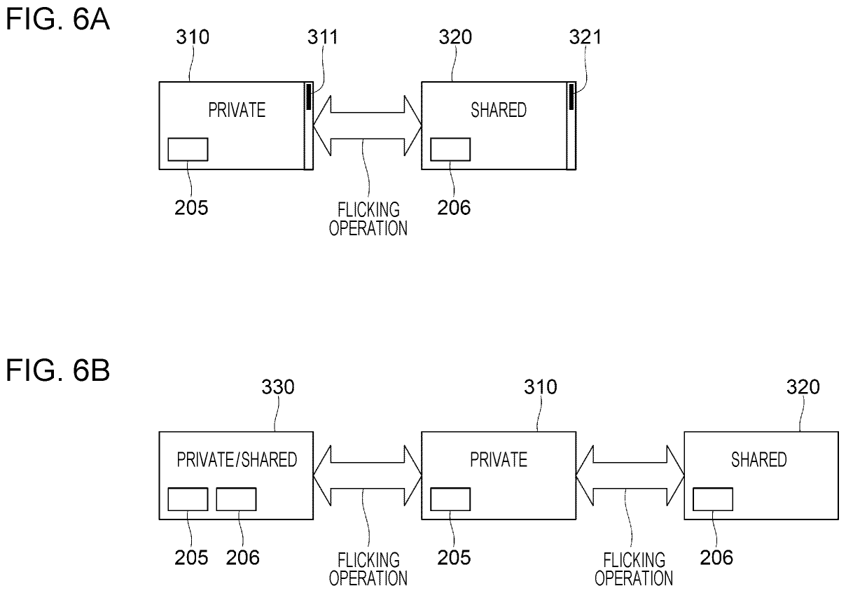

FIGS. 6A and 6B are diagrams for explaining switching between screens in a first exemplary embodiment. FIG. 6A illustrates a first switching example, and FIG. 6B illustrates a second switching example.

In the first switching example illustrated in FIG. 6A, switching between a display screen 310 and a display screen 320 is performed. In the second switching example illustrated in FIG. 6B, switching between the display screen 310, the display screen 320, and a display screen 330 is performed. In both the cases, switching between screens is performed by a flicking operation described above. Furthermore, switching between screens may be performed using the mechanical operation key 124 (see FIG. 4).

For the convenience of explanation, in FIGS. 6A and 6B, “private” is added to the display screen 310, “shared” is added to the display screen 320, and “private/shared” is added to the display screen 330.

In the first switching example illustrated in FIG. 6A, on the display screen 310, a private customized application icon including the icon 205 is displayed. Furthermore, on the display screen 320, a shared pinned icon including the icon 206 is displayed. More particularly, a private customized application icon is displayed on the display screen 310 but is not displayed on the display screen 320. Furthermore, a shared pinned icon is displayed on the display screen 320 but is not displayed on the display screen 310.

As described above, in this exemplary embodiment, a private customized application icon and a shared pinned icon are displayed in a separated manner. In other words, a shared pinned icon is displayed separately from a private customized application icon.

Since the display screen 310 includes the icon 205 but does not include the icon 206, the display screen 310 corresponds to the function selection screen 220 described above (see FIG. 5B). Since the display screen 330 includes both the icons 205 and 206, the display screen 330 corresponds to the function selection screen 210 described above (see FIG. 5A).

The user A may feel uncomfortable in dealing with a shared pinned icon and a private customized application icon in the same way in terms of display of icons on the touch panel display 123 of the operation panel 120 (see FIGS. 5A and 5B). This is because a private customized application icon is an icon that is added by the user A, whereas a shared pinned icon is an icon that is not added by the user A but is added by a machine administrator.

As described above, the user A is able to customize a shared pinned icon to be hidden and customize the shared pinned icon to be arranged in a different arrangement order. However, in the case where an added shared pinned icon is displayed in a region in which a private customized application icon is displayed, the layout of the private customized application icon may be changed.

Such a layout change may make the arrangement of icons look disorganized. Therefore, if a shared pinned icon is added in the case where customization setting is performed for a private customized application icon, an undesirable situation may occur. That is, the user A may feel as if a new display application were added without making any changes to customization settings, which may degrade operability.

Thus, in the first switching example in the first exemplary embodiment, a private customized application icon is displayed on the display screen 310, and a shared pinned icon is displayed on the display screen 320, which is different from the display screen 310.

Therefore, when a new shared pinned icon is added, the shared pinned icon is not displayed on the display screen 310. A change in the number of shared pinned icons does not affect the layout position of a private customized application icon or the presence or absence and position of the margin 207 (see FIG. 5B).

In the first exemplary embodiment, the icons 201 to 204 may be displayed on the display screen 310.

As illustrated in FIG. 6A, a scroll bar 311 is displayed on the right end of the display screen 310. The display screen 310 extends in the vertical direction, and all the icons included in the display screen 310 are not displayed on the touch panel display 123 (see FIGS. 5A and 5B). By moving the scroll bar 311 upwards or downwards, all the icons on the display screen 310 are able to be confirmed.

Furthermore, a scroll bar 321 is displayed on the right end of the display screen 320. By moving the scroll bar 321 upwards or downwards, all the icons on the display screen 320 are able to be confirmed.

The icon 205, which is a private customized application icon, is an example of a first image, and the icon 206, which is a shared pinned icon, is an example of a second image. The display screen 310 is an example of a first region, and the display screen 320 is an example of a second region. Touching the icon 205 or 206 is an example of an instruction from a user.

In the first exemplary embodiment, one of the display screen 310 and the display screen 320 is displayed in accordance with a flicking operation by the user. The flicking operation is an example of an operation by a user.

Furthermore, the display screen 330 is an example of a third region.

In the second switching example illustrated in FIG. 6B, switching between the three display screens 310, 320, and 330 is performed. That is, the second switching example is the same as the first switching example in switching between the display screens 310 and 320. However, the second switching example is different from the first switching example in that the display screen 330 is included among screens that are able to be switched to another screen.

On the display screen 330 illustrated in FIG. 6B, a private customized application icon such as the icon 205 and a shared pinned icon such as the icon 206 are displayed. Since the display screen 330 includes all the usable icons, the list of icons is able to be easily understood.

In the second switching example, by switching to one of the display screens 310 to 330 based on selection made by the user A, a screen that matches the intention of the user A is able to be displayed.

The scroll bars 311 and 321 illustrated in FIG. 6A may also be displayed on the display screens 310 and 320 in FIG. 6B. Furthermore, a scroll bar such as the scroll bar 311 or 321 may also be displayed on the right end of the display screen 330 in FIG. 6B.

An example of a process in the first exemplary embodiment will be described below.

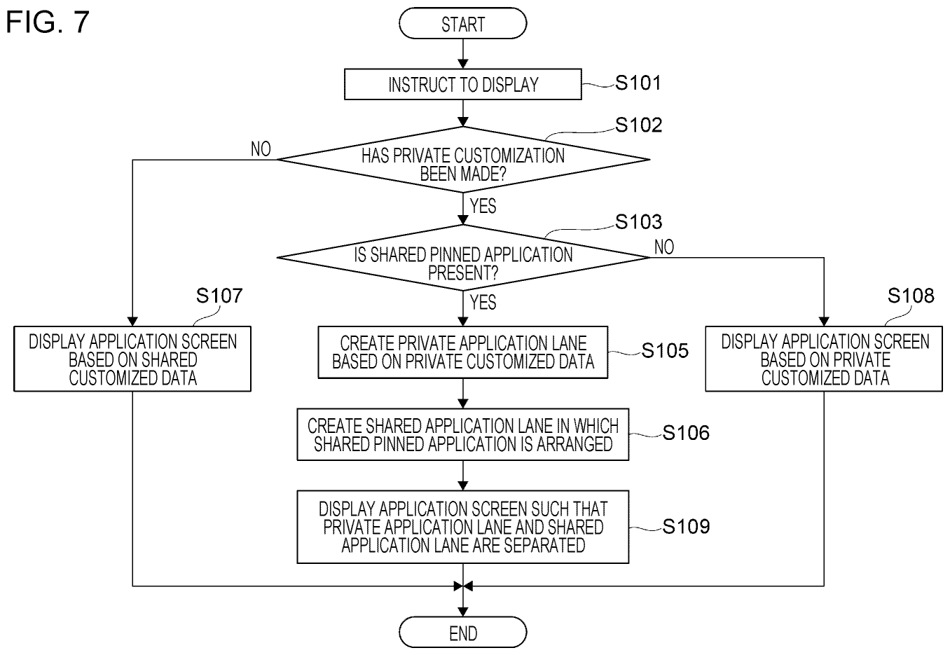

FIG. 7 is a flowchart illustrating an example of the process in the first exemplary embodiment. The process is performed by the UI control unit 141 (see FIG. 2).

In the example of the process illustrated in FIG. 7, when an instruction to display an application screen on the operation panel 120 is issued by the user (step 101), the process determines whether or not private customization on the application screen has been made by the user (step 102).

In the case where no private customization has been made (No in step 102), the process performs control for displaying the application screen based on shared customized data (step 107).

In the case where private customization has been made (Yes in step 102), the process determines whether or not a shared pinned application (see the icon 206 in FIG. 6A) is present (step 103).

In the case where a shared pinned application is present (Yes in step 103), the process creates a private application lane based on private customized data (step 105). Then, the process creates a shared application lane in which the shared pinned application is arranged (step 106). Furthermore, the process displays the application screen in such a manner that the private application lane and the shared application lane are separated from each other (step 109).

The private application lane mentioned above represents the display screen 310 (see FIG. 6A) on which the icon 205, which is a private customized application icon, is displayed. The shared application lane mentioned above represents the display screen 320 (see FIG. 6B) on which the icon 206, which is a shared pinned icon, is displayed.

The private application lane may be a single lane or may include a plurality of lanes. For example, the private application lane may include a first lane, a second lane, and so on. The same is applied to the shared application lane.

In the case where a plurality of lanes are included, an indication of whether a lane is a private application lane or a shared application lane may be provided or the private application lane and the shared application lane may be displayed in different colors.

In the case where no shared pinned application is present (No in step 103), the process displays the application screen based on private customized data (step 108).

After step 107, 108, or 109 described above is completed, the series of processing operations ends.

### Second Exemplary Embodiment

FIG. 8 is a diagram for explaining switching between screens in a second exemplary embodiment.

In the second exemplary embodiment illustrated in FIG. 8, switching between the display screens 310 to 330 is performed. The display screens 310 to 330 are the same as those in the first exemplary embodiment, and description of the display screens 310 to 330 will be omitted.

Switching between screens is performed by an operation on the switching image 340 displayed on the touch panel display 123 (for example, see FIG. 5A).

For example, in the case where the display screen 310 is displayed on the touch panel display 123, when the switching image 340 is pressed, switching to the display screen 330 is performed. When the switching image 340 is pressed again, the screen is switched back to the display screen 310. When the switching image 340 is pressed once again, switching to the display screen 320 is performed. When the switching image 340 is pressed next time, the initial display screen 310 is displayed.

As described above, the order of switching between the display screens 310 to 330 is set in advance. Switching between screens is performed in a toggle manner in accordance with an operation on the switching image 340.

Icons displayed on the display screen 320 may be aligned to the top side. As described above, customization setting on the display screen 320 may be made by the user A.

In the second exemplary embodiment, only the display screen 310 and the display screen 320 may be displayed, without the display screen 330 being displayed. In this case, switching between the display screen 310 and the display screen 320 is performed.

On the touch panel display 123 (for example, see FIG. 5A), the switching image 340 may be a region different from the display screens 310 to 330. In this case, the switching image 340 may be displayed without being superimposed on the display screens 310 to 330. However, the present disclosure is not limited to this configuration. The switching image 340 may be displayed superimposed on the display screens 310 to 330.

On the display screens 310 to 330, a scroll bar may be displayed as in the first exemplary embodiment.

The switching image 340 is an example of an image displayed along with the first region or the second region. One of the first region and the second region is displayed selectively based on an operation on the switching image 340. This operation is an example of an operation performed on the image.

### Third Exemplary Embodiment

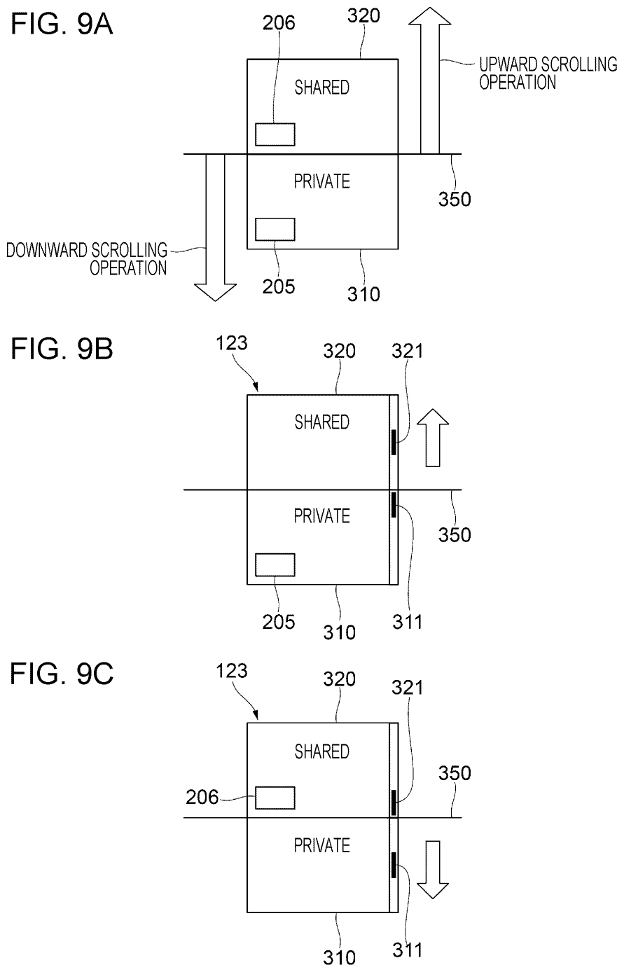

FIGS. 9A, 9B, and 9C are diagrams for explaining examples of switching between screens in a third exemplary embodiment. FIG. 9A is a diagram for explaining an initial screen, FIG. 9B illustrates a first switching example, and FIG. 9C illustrates a second switching example.

In the third exemplary embodiment illustrated in FIGS. 9A, 9B, and 9C, switching between the display screen 310 and the display screen 320 is performed. More particularly, a border line 350 indicating the boundary position between the display screen 310 and the display screen 320 is displayed in a horizontal direction between the display screen 310 and the display screen 320. That is, the border line 350 is located between the display screen 310 and the display screen 320.

The display screens 310 and 320 are the same as those in the first exemplary embodiment, and description of the display screens 310 and 320 will be omitted.

On the initial screen illustrated in FIG. 9A, the border line 350 is displayed in the substantially center position in the vertical direction. Furthermore, on the initial screen, the display screen 320 is displayed above the border line 350 and the display screen 310 is displayed below the border line 350. That is, both the display screen 310 and the display screen 320 are displayed on the touch panel display 123 (for example, see FIG. 5A). This display is an example of an aspect in which both the display screen 310 and the display screen 320 are displayed.

Switching between screens is implemented by a scrolling operation for vertically moving the screen so that a part that is not displayed is enabled to be displayed. Such a scrolling operation may be directly performed on the touch panel display 123 (for example, see FIG. 5A) or may be performed using the operation key 124 (see FIG. 4). A scrolling operation in an upward direction is called an “upward scrolling operation,” and a scrolling operation in a downward direction is called a “downward scrolling operation.” In the third exemplary embodiment, scrolling is performed in two directions: upward direction and downward direction.

An upward scrolling operation or a downward scrolling operation is an example of a scrolling operation in one of two directions.

In the first switching example illustrated in FIG. 9B, the scroll bar 311 is displayed on the display screen 310, and the scroll bar 321 is displayed on the display screen 320. An upward scrolling operation is performed on the scroll bar 321 on the display screen 320. Thus, the icon 206 disappears from the display screen 320, and a range different from that in FIG. 9A is displayed on the display screen 320.

In the second switching example illustrated in FIG. 9C, a downward scrolling operation is performed on the scroll bar 311 on the display screen 310. Thus, the icon 205 disappears from the display screen 310, and a range different from that in FIG. 9A is displayed on the display screen 310.

Although not illustrated in drawings, other switching examples may be considered. When an upward scrolling operation is performed on the initial screen illustrated in FIG. 9A, the display screen 320 disappears, and only the display screen 310 is displayed. When a downward scrolling operation is performed, the display screen 310 disappears, and only the display screen 320 is displayed.

When an upper end of the display screen 320 is displayed by an upward scrolling operation, further scrolling is not possible, and icon display does not change even if the upward scrolling operation is performed. When a lower end of the display screen 310 is displayed by a downward scrolling operation, further scrolling is not possible, and icon display does not change even if the downward scrolling operation is performed.

The icon 205 and other icons displayed on the display screen 310 may be aligned to the top side, and the icon 206 and other icons displayed on the display screen 320 may be aligned to the bottom side.

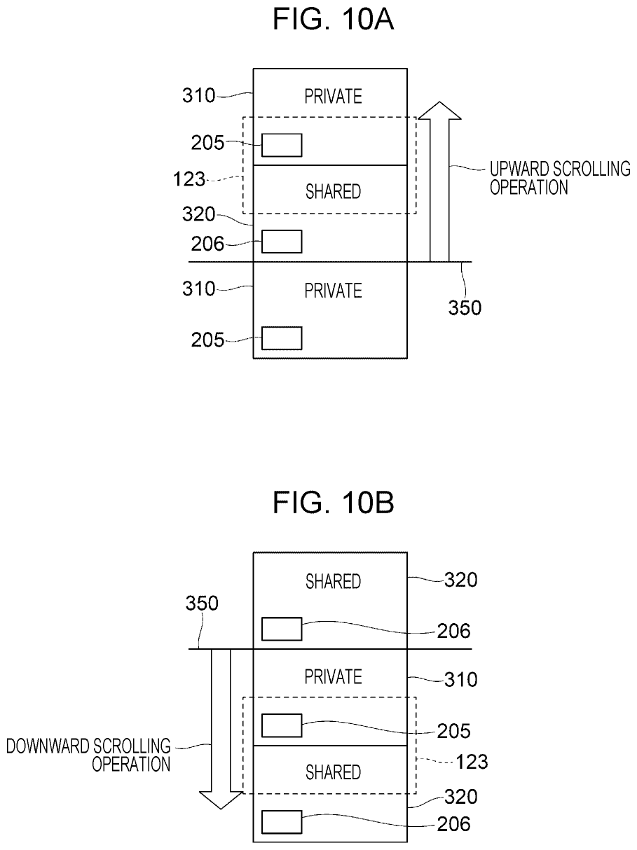

FIGS. 10A and 10B are diagrams for explaining application examples in the third exemplary embodiment. FIG. 10A illustrates display on the touch panel display 123 in the case where an upward scrolling operation is performed. FIG. 10B illustrates display on the touch panel display 123 in the case where a downward scrolling operation is performed. In FIGS. 10A and 10B, the touch panel display 123 is indicated by a broken line.

In the application examples illustrated in FIGS. 10A and 10B, positional relationship between the display screens 310 and 320 and the border line 350 is the same as that illustrated in FIGS. 9A, 9B, and 9C.

Features of the application examples illustrated in FIGS. 10A and 10B that are different from the examples illustrated in FIGS. 9A, 9B, and 9C will be described.

When the upper end of the display screen 320 is displayed by an upward scrolling operation and the upward scrolling operation still continues to be performed, the lower end of the display screen 310 is displayed on the touch panel display 123, as illustrated in FIG. 10A.

Furthermore, when the lower end of the display screen 310 is displayed by a downward scrolling operation and the downward scrolling operation still continues to be performed, the upper end of the display screen 320 is displayed on the touch panel display 123, as illustrated in FIG. 10B.

That is, in the application examples, a drum-type display system is adopted in which the display screens 310 and 320 are displayed in a circular manner when a scrolling operation is performed in one direction. Thus, the operability of the user A is improved.

The first exemplary embodiment, the second exemplary embodiment, and the third exemplary embodiment described above will be explained again.

In the first exemplary embodiment and the second exemplary embodiment, display of the display screen 310 or the display screen 320 is performed in an aspect in which one of the display screen 310 and the display screen 320 is displayed in accordance with an operation by a user (see FIGS. 6A and 6B or FIG. 8).

In the first exemplary embodiment and the second exemplary embodiment described above, one of the display screens 310 to 330, for example, the display screen 310, is switched to one of the remaining display screens, for example, the display screen 330 (for example, see FIG. 6B or FIG. 8), in accordance with an operation by a user.

In the first exemplary embodiment, the display screen 310 and the display screen 320 are displayed extending in the vertical direction, and a displayed screen, out of the display screen 310 and the display screen 320, is able to be scrolled in the vertical direction (see FIG. 6A).

In the second exemplary embodiment, an operation by a user is an operation on the operation key 124 (see FIG. 4) displayed along with the display screen 310 or the display screen 320, and one of the display screen 310 and the display screen 320 is displayed selectively in accordance with the operation (see FIG. 8).

In the third exemplary embodiment described above, display of the display screen 310 or the display screen 320 is performed in an aspect in which both the display screen 310 and the display screen 320 are displayed (see FIGS. 9A, 9B, and 9C).

In the aspect in which both the display screen 310 and the display screen 320 are displayed, when an upward scrolling operation is performed on one of the display screen 310 and the display screen 320, for example, on the display screen 310, although display on the display screen 310 is scrolled, display on the display screen 320 is not scrolled (see FIGS. 9A, 9B, and 9C).

Furthermore, in the aspect in which both the display screen 310 and the display screen 320 are displayed, in the case where one of the display screen 310 and the display screen 320 is displayed, for example, the display screen 310 is switched to the display screen 320 by an upward scrolling operation, out of an upward scrolling operation and a downward scrolling operation. In this case, by an upward scrolling operation, the display screen 310 is switched to the display screen 320, and the display screen 320 is switched to the display screen 310 (see FIG. 10A).

In the first exemplary embodiment, the second exemplary embodiment, and the third exemplary embodiment described above, contents of control regarding display of the icon 205 on the display screen 310 and contents of control regarding display of the icon 206 on the display screen 320 may be selected individually.

Contents regarding display mentioned above represent customization settings for controlling whether or not to display the icon 205 or 206 and controlling the position of the icon 205 or 206. Customization settings for the icon 205 or 206 is reflected in display on the display screen 320.

Furthermore, in the case where customization setting is made, the icon 206 may be displayed on the display screen 320. In the case where customization setting is not made, the icon 206 may be displayed on the display screen 310.

In each of the first exemplary embodiment, the second exemplary embodiment, and the third exemplary embodiment described above, a display screen on which the last operation was performed may be stored, and the stored display screen may be displayed the next time the operation panel is used. However, the present disclosure is not limited to this configuration. A predetermined display screen may be displayed the next time the operation panel is used.

Furthermore, although a screen switching operation is implemented by a flicking operation or using the operation key 124 (see FIG. 4) in the first exemplary embodiment, implemented by touching the switching image 340 in the second exemplary embodiment, and implemented by a scrolling operation in the third exemplary embodiment, the screen switching operation is not necessarily implemented as described above. The screen switching operations mentioned above may be applied to other exemplary embodiments.

A user terminal, which is not illustrated in drawings, may connect to the information processing apparatus 100 according to an exemplary embodiment via a network. The user terminal may be capable of logging into the information processing apparatus 100.

The user terminal may be owned by the user A or may be owned by a machine administrator. In these cases, the user A or the machine administrator is able to allow the user terminal to display the display screens 310 to 330 and to customize icons.

The exemplary embodiments of the present disclosure have been described above. The technical scope of the present disclosure is not limited to the scope described in the exemplary embodiments. It is obvious from the scope of the claims that various changes or improvements made to the exemplary embodiments are also included in the technical scope of the present disclosure.

The present disclosure is also applicable to a program and a program product.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A display control system comprising:
a processor configured to:
be capable of displaying in a first region a first image for executing, when receiving an instruction from a user, processing set in advance by the user; and
be capable of displaying in a second region that is different from the first region a second image for executing, when receiving an instruction from the user, processing set in advance by an administrator.
(((2)))

The display control system according to (((1))), wherein display of the first image or the second image is performed in an aspect in which one of the first region and the second region is displayed in accordance with an operation by the user.
(((3)))

The display control system according to (((2))), wherein in the aspect in which one of the first region and the second region is displayed, the first region and the second region extend in one direction, and the one of the first region and the second region that is displayed is able to be scrolled in the one direction.
(((4)))

The display control system according to (((2))),
wherein the operation by the user is an operation performed on an image displayed along with the first region or the second region, and
wherein in the aspect in which one of the first region and the second region is displayed, the one of the first region and the second region is displayed selectively in accordance with the operation performed on the image.
(((5)))

The display control system according to (((1))), wherein display of the first image or the second image is performed in an aspect in which both the first region and the second region are displayed.
(((6)))

The display control system according to (((5))), wherein in the aspect in which both the first region and the second region are displayed, in a case where both the first region and the second region are displayed, when a scrolling operation in one of two directions is performed on one of the first region and the second region, display of the one of the first region and the second region is scrolled but display of the other one of the first region and the second region is not scrolled.
(((7)))

The display control system according to (((5))),
wherein in the aspect in which both the first region and the second region are displayed, in a case where one of the first region and the second region is displayed, display of the one of the first region and the second region is switched to display of the other one of the first region and the second region in accordance with a scrolling operation in one of two directions, and
wherein in accordance with the scrolling operation in the one direction, display of the one of the first region and the second region is switched to display of the other one of the first region and the second region, and display of the other one of the first region and the second region is switched to display of the one of the first region and the second region.
(((8)))

The display control system according to any one of (((1))) to (((7))), wherein individual selection of contents of control regarding display of the first image in the first region and contents of control regarding display of the second image in the second region is able to be made.
(((9)))

The display control system according to (((8))),
wherein the first image and the second image are able to be displayed in a third region that is different from the first region and the second region, and
wherein the individual selection is reflected in display of the third region.
(((10)))

The display control system according to (((9))),
wherein in accordance with an operation on a switching button, one of the first region, the second region, and the third region is switched to a remaining one of the first region, the second region, and the third region.
(((11)))

The display control system according to any one of (((8))) to (((10))),
wherein in a case where the individual selection is made, the second image is able to be displayed in the second region, and
wherein in a case where the individual selection is not made, the second image is displayed in the first region.
(((12)))

An information processing apparatus comprising:
a first image displaying unit that displays in a first region a first image for executing, when receiving an instruction from a user, processing set in advance by the user; and
a second image displaying unit that displays in a second region that is different from the first region a second image for executing, when receiving an instruction from the user, processing set in advance by an administrator.
(((13)))

A program for causing an information processing apparatus to execute a process comprising:
displaying in a first region a first image for executing, when receiving an instruction from a user, processing set in advance by the user; and
displaying in a second region that is different from the first region a second image for executing, when receiving an instruction from the user, processing set in advance by an administrator.

What is claimed is:

1. A display control system comprising:
a processor configured to:
be capable of displaying in a first region a first image for executing, when receiving an instruction from a user, processing set in advance by the user; and
be capable of displaying in a second region that is different from the first region a second image for executing, when receiving an instruction from the user, processing set in advance by an administrator.

2. The display control system according to claim 1, wherein display of the first image or the second image is performed in an aspect in which one of the first region and the second region is displayed in accordance with an operation by the user.

3. The display control system according to claim 2, wherein in the aspect in which one of the first region and the second region is displayed, the first region and the second region extend in one direction, and the one of the first region and the second region that is displayed is able to be scrolled in the one direction.

4. The display control system according to claim 2,
wherein the operation by the user is an operation performed on an image displayed along with the first region or the second region, and
wherein in the aspect in which one of the first region and the second region is displayed, the one of the first region and the second region is displayed selectively in accordance with the operation performed on the image.

5. The display control system according to claim 1, wherein display of the first image or the second image is performed in an aspect in which both the first region and the second region are displayed.

6. The display control system according to claim 5, wherein in the aspect in which both the first region and the second region are displayed, in a case where both the first region and the second region are displayed, when a scrolling operation in one of two directions is performed on one of the first region and the second region, display of the one of the first region and the second region is scrolled but display of the other one of the first region and the second region is not scrolled.

7. The display control system according to claim 5,
wherein in the aspect in which both the first region and the second region are displayed, in a case where one of the first region and the second region is displayed, display of the one of the first region and the second region is switched to display of the other one of the first region and the second region in accordance with a scrolling operation in one of two directions, and
wherein in accordance with the scrolling operation in the one direction, display of the one of the first region and the second region is switched to display of the other one of the first region and the second region, and display of the other one of the first region and the second region is switched to display of the one of the first region and the second region.

8. The display control system according to claim 1, wherein individual selection of contents of control regarding display of the first image in the first region and contents of control regarding display of the second image in the second region is able to be made.

9. The display control system according to claim 8,
wherein the first image and the second image are able to be displayed in a third region that is different from the first region and the second region, and
wherein the individual selection is reflected in display of the third region.

10. The display control system according to claim 9, wherein in accordance with an operation on a switching button, one of the first region, the second region, and the third region is switched to a remaining one of the first region, the second region, and the third region.

11. The display control system according to claim 8,
wherein in a case where the individual selection is made, the second image is able to be displayed in the second region, and
wherein in a case where the individual selection is not made, the second image is displayed in the first region.

12. An information processing apparatus comprising:
a first image displaying unit that displays in a first region a first image for executing, when receiving an instruction from a user, processing set in advance by the user; and
a second image displaying unit that displays in a second region that is different from the first region a second image for executing, when receiving an instruction from the user, processing set in advance by an administrator.

13. A non-transitory computer readable medium storing a program causing a computer to execute a process for information processing, the process comprising:
displaying in a first region a first image for executing, when receiving an instruction from a user, processing set in advance by the user; and
displaying in a second region that is different from the first region a second image for executing, when receiving an instruction from the user, processing set in advance by an administrator.
